(19) United States
(12) Patent Application Publication
(10) Pub. No.: US 2010/0201726 A1
(43) Pub. Date: Aug. 12, 2010

(54) FLUID EJECTING APPARATUS AND MANUFACTURING METHOD OF FLUID EJECTING APPARATUS

(75) Inventors: Takamitsu Kondo, Shiojiri-shi (JP); Toru Takahashi, Azumino-shi (JP); Toru Miyamoto, Shiojiri-shi (JP); Hirokazu Kasahara, Okaya-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/702,219

(22) Filed: Feb. 8, 2010

(30) Foreign Application Priority Data
Feb. 10, 2009 (JP) 2009-028714

(51) Int. Cl. B41J 29/38; B21D 53/76

(52) U.S. Cl. 347/10; 29/890.1

(57) ABSTRACT

A manufacturing method of a fluid ejecting apparatus includes: forming first and second test patterns by ejecting fluid from first and second nozzle rows which intersect with a relative movement direction of a medium, wherein the first nozzle row forms the first test pattern by ejecting the fluid in accordance with a first driving pulse and the second nozzle row forms the second test pattern by ejecting the fluid in accordance with a second driving pulse; measuring the density of the first test pattern and the density of the second test pattern; and correcting a parameter of the first driving pulse and a parameter of the second driving pulse such that the density of the first test pattern and the density of the second test pattern become a common target density.

### BACKGROUND

1. Technical Field

The present invention relates to a manufacturing method of a fluid ejecting apparatus.

2. Related Art

A line type ink jet printer is considered which is provided with a plurality of heads disposed in a zigzag form and forms an image by ejecting liquid onto a medium which is transported. In such a printer, the heads are disposed such that adjacent heads partially overlap in the transport direction of the medium. The optimal driving voltages of the heads are different for every head, and they need to be determined for every head. A setting method of an optimal driving waveform is disclosed in JP-A-2006-240127.

Another examples of the above-described related arts are disclosed in JP-A-2006-264069 and JP-A-2005-132034.

In the line type ink jet printer as described above, a plurality of heads are arranged in a nozzle row direction. However, there are cases where these heads respectively have different liquid ejecting characteristics due to manufacturing error. In such a case, for example, if the same driving voltage is applied to each head, an image having a different density for each head is formed. Accordingly, it is necessary to correct the difference in density which occurs for each head with respect to the image formed.

### SUMMARY

An advantage of some aspects of the invention is that it corrects a difference in density which occurs for each head.

According to a first aspect of the invention, there is provided a manufacturing method of a fluid ejecting apparatus including: forming first and second test patterns by ejecting fluid from first and second nozzle rows which intersect with a relative movement direction of a medium, wherein the first nozzle row forms the first test pattern by ejecting the fluid in accordance with a first driving pulse and the second nozzle row forms the second test pattern by ejecting the fluid in accordance with a second driving pulse; measuring the density of the first test pattern and density of the second test pattern; and correcting a parameter of the first driving pulse and a parameter of the second driving pulse such that the density of the first test pattern and the density of the second test pattern become a common target density.

Other aspects of the invention will become apparent from the description of this specification and the accompanying drawings.

### BRIEF DESCRIPTION OF THE DRAWINGS

The invention will be described with reference to the accompanying drawings, wherein like numbers reference like elements.

FIG. 1 is an explanatory view of terms.

FIG. 2 is a block diagram showing the configuration of a printing system.

FIG. 3 is a perspective view for explaining the transport processing and the dot forming processing of a printer.

FIG. 4 is an explanatory view of the arrangement of a plurality of heads in a head unit.

FIG. 5 is a view explaining the structure of the head.

FIG. 6 is a view explaining a driving signal.

FIG. 7 is an explanatory view of the aspects of head arrangement and dot formation.

FIG. 8 is a view showing test patterns in an embodiment.

FIG. 9 is a flow chart for explaining a driving voltage setting method in the embodiment.

FIG. 10 is a flow chart for explaining driving voltage versus density measurement processing.

FIG. 11 is a flow chart for explaining driving voltage setting processing.

FIG. 12 is a table showing the calculated average density for every driving voltage in each ink color of each head.

FIG. 13 is a table showing the reference density of each ink color.

FIG. 14 is a table showing the obtained coefficients a and b of a linear expression.

FIG. 15 is a table showing an appropriate driving voltage for every ink color of each head.

FIG. 16 is a table showing an appropriate driving voltage of each head.

FIG. 17 is a view showing one example of a driving signal when dots having a plurality of sizes can be formed.

FIG. 18 is a graph showing the relationship between the elapsed time and a density.

FIG. 19 is an explanatory view of processing by a printer driver.

FIG. 20A is an explanatory view of an aspect when dots were ideally formed, FIG. 20B is an explanatory view when density unevenness was generated, and FIG. 20C is a view showing an aspect in which the generation of density unevenness was suppressed.

FIG. 21 is a view showing the flow of correction value acquisition processing.

FIG. 22 is an explanatory view of a pattern CP for correction.

FIG. 23 is a graph showing the calculated density for every raster line with respect to sub-patterns in which command gradation values are Sa, Sb, and Sc.

FIG. 24A is an explanatory view of the procedure of calculating a density correction value Hb for correcting a command gradation value Sb with respect to an i-th raster line, and FIG. 24B is an explanatory view of the procedure of calculating a density correction value Hb for correcting a command gradation value Sb with respect to a j-th raster line.

FIG. 25 is a view showing correction value tables stored in a memory.

FIG. 26 is a flow chart of print processing which a printer driver performs under the direction of a user.

### DESCRIPTION OF EXEMPLARY EMBODIMENTS

At least the following aspects will be clarified by the description of this specification and the accompanying drawings.

A manufacturing method of a fluid ejecting apparatus will be clarified which includes: forming first and second test patterns by ejecting fluid from first and second nozzle rows which intersect with a relative movement direction of a medium, wherein the first nozzle row forms the first test pattern by ejecting the fluid in accordance with a first driving pulse and the second nozzle row forms the second test pattern by ejecting the fluid in accordance with a second driving pulse; measuring the density of the first test pattern and density of the second test pattern; and correcting a parameter of the first driving pulse and a parameter of the second driving pulse such that the density of the first test pattern and the density of the second test pattern become a common target density. According to this method, a difference in density which occurs for each head can be corrected.

In the manufacturing method of a fluid ejecting apparatus, it is preferable that the parameter of the first driving pulse and the parameter of the second driving pulse be the amplitude values of the voltages of the respective driving pulses.

In addition, it is preferable that the first test pattern be formed in a plurality of numbers by varying the parameter of the first driving pulse, the second test pattern be formed in a plurality of numbers by varying the parameter of the second driving pulse, the parameter of the first driving pulse be corrected such that the density of the first test pattern which the first nozzle row forms becomes a reference density, on the basis of a value linearly-interpolated based on the densities of the plurality of first test patterns which were formed, and the parameter of the second driving pulse be corrected such that the density of the second test pattern which the second nozzle row forms becomes the reference density, on the basis of a value linearly-interpolated based on the densities of the plurality of second test patterns which were formed.

Additionally, it is preferable that the first test pattern be a test pattern in which dots are formed at all pixels by the first nozzle row, and the second test pattern be a test pattern in which dots are formed at all pixels by the second nozzle row.

Further, it is preferable that (A) in the formation of the first test pattern and the second test pattern, the first nozzle row be one among a plurality of first nozzle row groups which are provided in a first head, the respective nozzle rows of the first nozzle row group form the first test patterns by ejecting fluid of different colors in accordance with the first driving pulse, the second nozzle row be one among a plurality of second nozzle row group which are provided in a second head, and the respective nozzle rows of the second nozzle row group form the second test patterns by ejecting fluid of different colors in accordance with the second driving pulse, (B) in the measurement of the density of the first test pattern and density of the second test pattern, the densities of the first and second test patterns related to each color of the fluid be measured, and (C) in the correction of the parameter of the first driving pulse and the parameter of the second driving pulse, such parameters of the first and second driving pulses that the densities of the first and second test patterns become a common target density for every color of the fluid be sought out, the average of the sought-out parameters of the first driving pulses of the first nozzle row group be set as a common parameter of the first driving pulses in the first nozzle row group, and the average of the sought-out parameters of the second driving pulses of the second nozzle row group be set as a common parameter of the second driving pulses in the second nozzle row group.

Additionally, it is preferable that the correction of the parameters be further performed on the basis of a change in a density with the elapsed time from the formation of the first test pattern and the second test pattern. Moreover, it is preferable that the manufacturing method of a fluid ejecting apparatus further include: forming a pattern for correction for performing the density correction for every pixel row composed of pixels arranged in the relative movement direction, on the medium; and calculating a density correction value for correcting the density for every pixel row on the basis of the pattern for correction. In addition, it is preferable that a density of the formed pattern for correction be measured for every pixel row, and then the density correction value be calculated on the basis of the measured density for every pixel row.

According to the above aspect, a difference in a density which occurs for each head can be corrected.

### Embodiment

### Description of Terms

First, the meaning of terms which are used in the description of this embodiment will be explained.

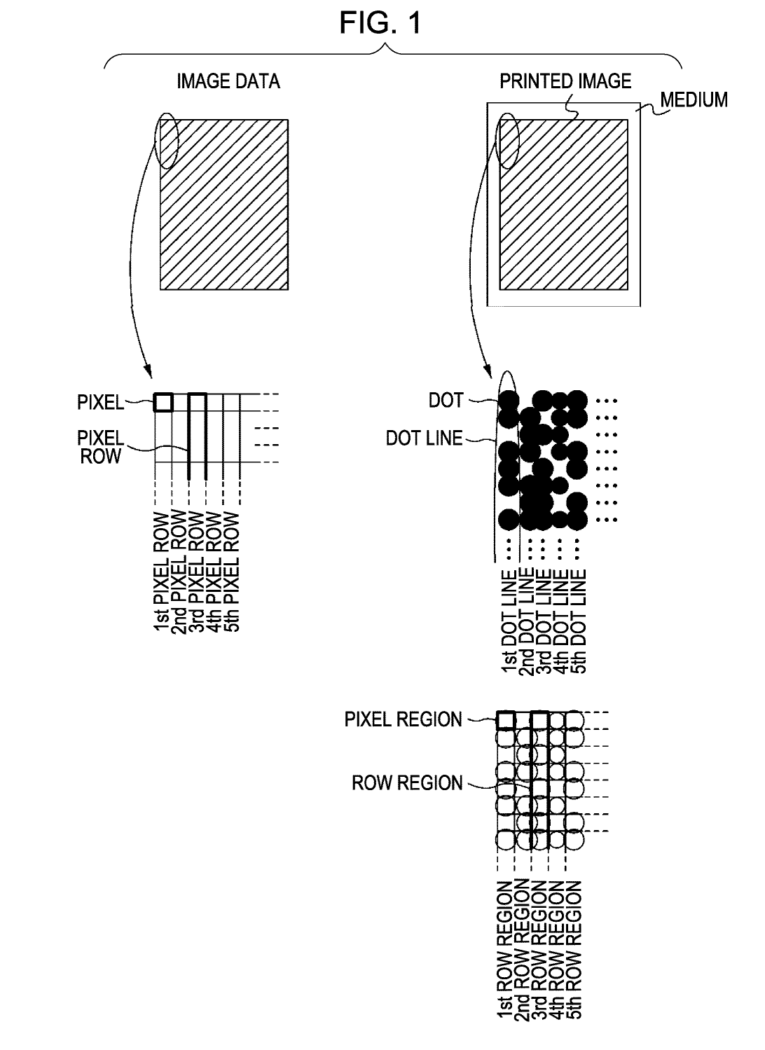

FIG. 1 is an explanatory view of terms.

The term “printed image” is an image printed on a piece of paper. A printed image of an ink jet printer is constituted of a countless number of dots formed on a piece of paper.

The term “dot line” is the row of dots arranged in a direction (movement direction) in which the head and the paper relatively move. In the case of a line printer as in an embodiment which will be described later, the “dot line” means the row of dots arranged in the transport direction of a piece of paper. On the other hand, in the case of a serial printer which performs printing by a head mounted on a carriage, the “dot line” means the row of dots arranged in the movement direction of the carriage. A number of dot lines are arranged in a direction perpendicular to the movement direction, so that a printed image is constituted. As shown in the drawing, a dot line which is at an n-th position is called an n-th dot line.

The term “image data” is data representing a two-dimensional image. In the embodiment which will be described later, there is image data of 256 gradations, image data of 4 gradations, or the like. Moreover, there are also cases where the image data indicates image data before conversion to print resolution which will be described later, and indicates image data after the conversion.

The term “print image data” is image data used when printing an image on a piece of paper. In a case where a printer controls the formation of dots with 4 gradations (a large dot, a middle-size dot, a small dot, and no dot), print image data of 4 gradations represents the formation state of dots constituting a printed image.

The term “read image data” is image data read by a scanner.

The term “pixel” is a minimum unit constituting an image. The pixels are two-dimensionally disposed, so that an image is constituted.

The term “pixel row” is the row of pixels arranged in a given direction on image data. As shown in the drawing, a pixel row of an n-th row is called an n-th pixel row.

The term “pixel data” is data representing a gradation value of a pixel. In the embodiment which will be described later, before halftone processing, it represents data of multi-gradation such as 256 gradations, and in the case of print image data of 4 gradations after halftone processing, each pixel data is 2-bit data and represents the dot forming states (a large dot, a middle-size dot, a small dot, and no dot) of a certain pixel.

The term “pixel region” is a region on a piece of paper, which corresponds to a pixel in image data. For example, in a case where the resolution of print image data is 360 dpi×360 dpi, the “pixel region” is a region of a square shape having one side of 1/360 inch, and is a pixel on a piece of paper.

The term “row region” is a region on a piece of paper, which corresponds to a pixel row, and is a pixel row on a piece of paper. For example, in a case where the resolution of print image data is 360 dpi×360 dpi, the row region is an elongated region of 1/360 inch width. There are also cases where the “row region” means a region on a piece of paper, which corresponds to a pixel row on print image data, and where it means a region on a piece of paper, which corresponds to a pixel row on read image data. At the lower right of the drawing, the row regions of the former case are shown. The “row region” of the former case is also a target position for the formation of a dot line. In a case where a dot line is exactly formed at a row region, the dot line corresponds to a raster line. The “row region” of the latter case is also a measurement position (measurement range) on a piece of paper, where the pixel row on read image data is read, in other words, a position on a piece of paper, where an image (image piece) expressed by pixel rows is present. As shown in the drawing, a row region which is at an n-th position is called an n-th row region. The n-th row region becomes a target position for the formation of an n-th dot line.

The term “image piece” means a portion of an image. On image data, an image expressed by a certain pixel row becomes an “image piece” of an image which is represented by image data. Further, in a printed image, an image expressed by a certain raster line becomes an “image piece” of the printed image. Additionally, in a printed image, an image expressed by color-developing in a certain row region also corresponds to an “image piece” of the printed image.

On the other hand, at the lower right of FIG. 1, the relationship between a pixel region and dots is shown. As a result of the fact that the second dot line has deviated from the second row region due to the influence of a manufacturing error of the head, the density of the second row region becomes lighter. Additionally, in the fourth row region, as a result of the fact that dots have become smaller due to the influence of a manufacturing error of the head, the density of the fourth row region becomes lighter. Since it is necessary to explain such density unevenness or a density unevenness correction method, in this embodiment, the meanings of and the relationship among the “dot line”, the “pixel row”, and the “row region”, and the like are explained in accordance with the above-mentioned content.

However, the meaning of general terms such as the “image data” and the “pixel” may be appropriately construed in accordance with not only the above-mentioned description, but also with ordinary common-sense in technology.

Moreover, in the following explanation, explanation is performed assuming that when a gradation value is high, a density is high, and when a gradation value is low, a density is low. Further, in the explanation, a case where a density is high corresponds to a case where brightness is low.

### Concerning Printing System

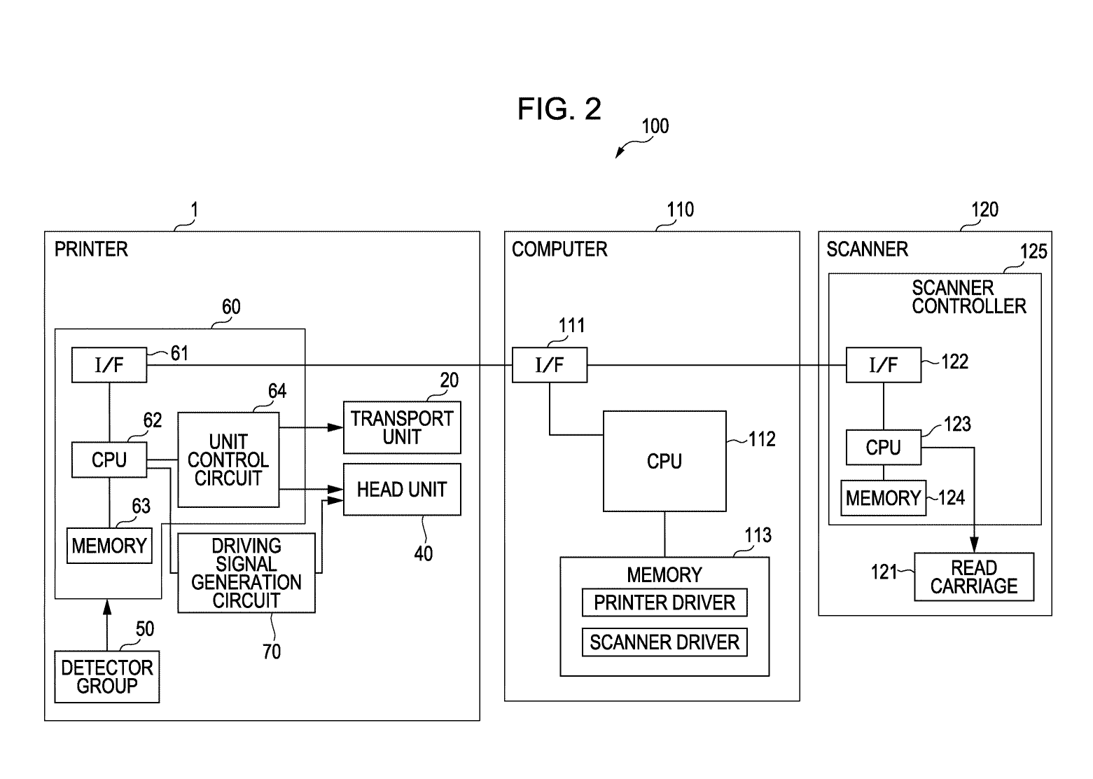

FIG. 2 is a block diagram showing the configuration of a printing system 100. The printing system 100 of this embodiment is a system having a printer 1, a computer 110, and a scanner 120, as shown in FIG. 2.

The printer 1 is a fluid ejecting apparatus which ejects ink as fluid onto a medium, thereby forming (printing) an image on the medium, and in this embodiment, is a color ink jet printer. The printer 1 can print an image on the plural kinds of mediums such as paper, cloth, and a film sheet. The configuration of the printer 1 will be described later.

The computer 110 has an interface 111, a CPU 112, and a memory 113. The interface 111 performs the delivery and receipt of data between the printer 1 and the scanner 120. The CPU 112 is to perform the overall control of the computer 110 and executes various programs installed in the computer 110. The memory 113 stores various program or various data. Among the programs installed in the computer 110, there are a printer driver for converting the image data outputted from an application program into print data, and a scanner driver for controlling the scanner 120. Moreover, the computer 110 outputs the print data generated by the printer driver to the printer 1.

The scanner 120 has a scanner controller 125 and a read carriage 121. The scanner controller 125 has an interface 122, a CPU 123, and a memory 124. The interface 122 performs communication between the scanner controller and the computer 110.

The CPU 123 performs the overall control of the scanner 120. It controls, for example, the read carriage 121. The memory 124 stores a computer program and the like. The read carriage 121 has three sensors (such as CCDs) (not shown) corresponding to, for example, R (red), G (green), and B (blue).

By the above-described configuration, the scanner 120 irradiates a manuscript placed on a manuscript support (not shown) with light and detects the reflected light by each sensor of the read carriage 121, thereby reading an image of the manuscript, and thus acquiring the color information of the image. Then, the data (read data) representing the color information of the image is transmitted to the scanner driver of the computer 110 through the interface 122.

### Configuration of Printer

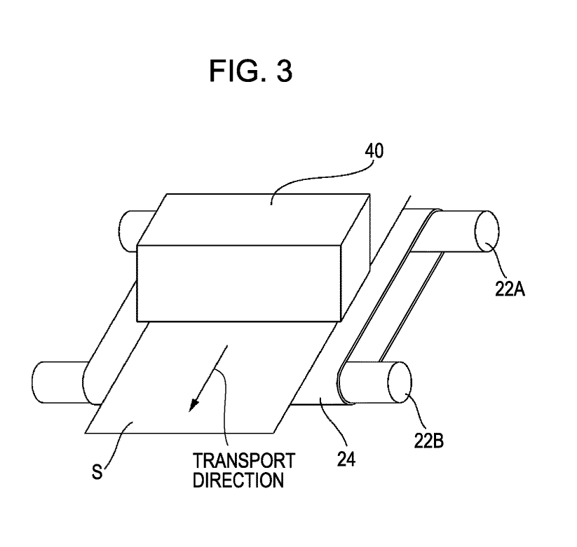

FIG. 3 is a perspective view for explaining the transport processing and the dot forming processing of the printer 1. Here, the configuration of the printer is explained also with reference to the block diagram of FIG. 2.

The printer 1 has a transport unit 20, a head unit 40, a detector group 50, and a controller 60. The controller 60 includes an interface 61 for connecting the printer with the computer 110, a CPU 62 which is an arithmetic device, a memory 63 corresponding to a storage section, and a unit control circuit 64 for controlling each unit.

The printer 1 which has received print data from the computer 110 which is an external apparatus controls each unit (the transport unit 20 and the head unit 40) by the controller 60. The controller 60 controls each unit on the basis of the print data received from the computer 110, so as to print an image on a piece of paper. The conditions in the printer 1 are monitored by the detector group 50, and the detector group 50 outputs detection results to the controller 60. The controller 60 controls each unit on the basis of the detection results outputted from the detector group 50.

The transport unit 20 is for transporting a medium (for example, a piece of paper S or the like) in a given direction (hereinafter referred to as a transport direction). The transport unit 20 has an upstream side roller 22A, a downstream side roller 22B, and a belt 24. If a transport motor (not shown) rotates, the upstream side roller 22A and the downstream side roller 22B rotate, so that the belt 24 rotates. The paper S fed is transported up to a printable region (a region facing the head) by the belt 24. As the belt 24 transports the paper S, the paper S is moved in the transport direction relative to the head unit 40. The paper S which has passed through the printable region is discharged to the outside by the belt 24. Further, the paper S which is being transported is electrostatic- or vacuum-adsorbed to the belt 24.

The head unit 40 is for discharging ink onto the paper S. The head unit 40 discharges ink onto the paper S which is being transported, thereby forming dots on the paper S, and thus printing an image on the paper S. The printer 1 of this embodiment is a line printer, and the head unit 40 can form dots for a paper width at a time.

A driving signal generation circuit 70 generates a driving signal for applying to a piezo element PZT. In this embodiment, six heads, a first head 41A to a sixth head 41F, are used, and different driving signals are supplied to the respective heads. Furthermore, one driving signal is used as a common driving signal to all the nozzle rows of the head to which it is supplied.

The driving signal generation circuit 70 generates and outputs six driving signals COM1 to COM6. Moreover, a driving pulse of each driving signal is constituted such that the setting of a parameter such as amplitude is possible.

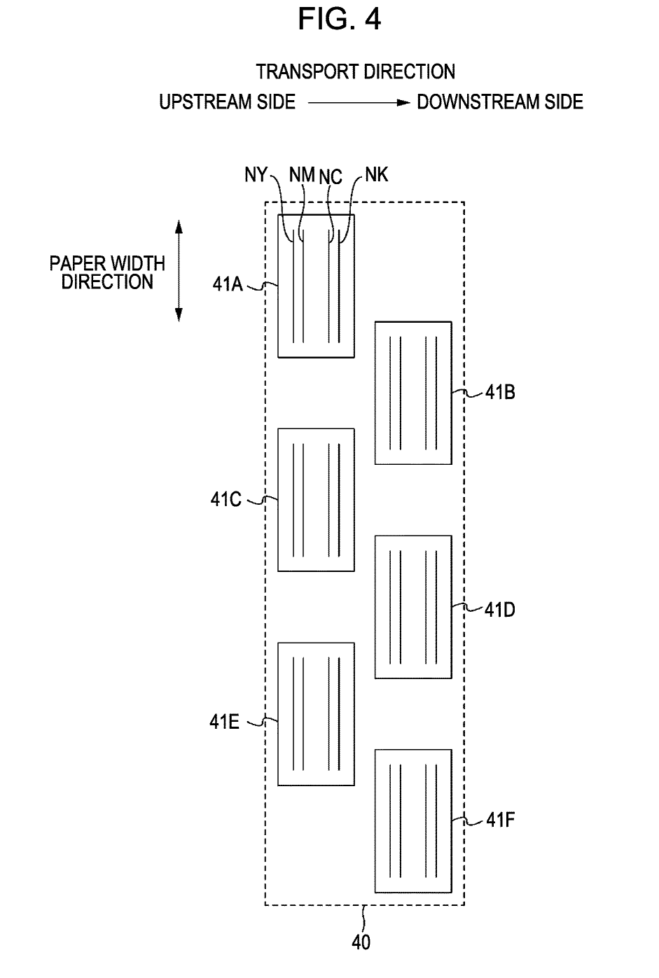

FIG. 4 is an explanatory view of the arrangement of a plurality of heads in the head unit 40. As shown in the drawing, a number of heads 41 are arranged in a zigzag form along a paper width direction. In addition, here, the nozzle rows which can be seen only from the lower side are shown to be able to be observed from the upper side for the ease of explanation.

In each head, although not shown in the drawing, there are formed a black ink nozzle row NK, a cyan ink nozzle row NC, a magenta ink nozzle row NM, and a yellow ink nozzle row NY. Each nozzle row is provided with a plurality of (here, 360) nozzles which discharge ink. A number of nozzles of each nozzle row are arranged at a constant nozzle pitch (here, 360 dpi) along the paper width direction. Further, the nozzles of adjacent heads are arranged such that eight nozzles of the end portions of the respective heads overlap with each other in the transport direction, in other words, are positioned at the same coordinate in the coordinates with the paper width direction as an axis.

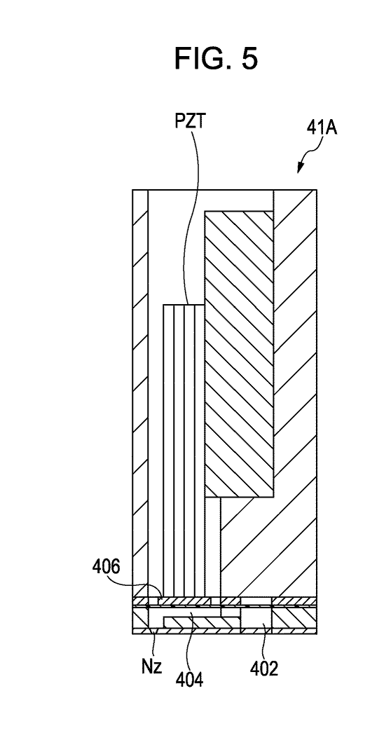

FIG. 5 is a view explaining the structure of the head. In this embodiment, the first head 41A to the sixth head 41F are provided. Since the structures of all of these heads are approximately the same, here, the structure of only the first head 41A is explained. In the drawing, there are shown a nozzle Nz, the piezo element PZT, an ink supply path 402, a nozzle communication path 404, and an elastic plate 406.

To the ink supply path 402, ink drops are supplied from an ink tank (not shown). Then, these ink drops are supplied to the nozzle communication path 404. To the piezo element PZT, the driving pulse of a driving signal which will be described later is applied. If the driving pulse is applied, the piezo element PZT expands and contracts in accordance with driving pulse signals, thereby vibrating the elastic plate 406. Thus, an ink drop of the amount corresponding to the amplitude of the driving pulse is discharged from the nozzle Nz.

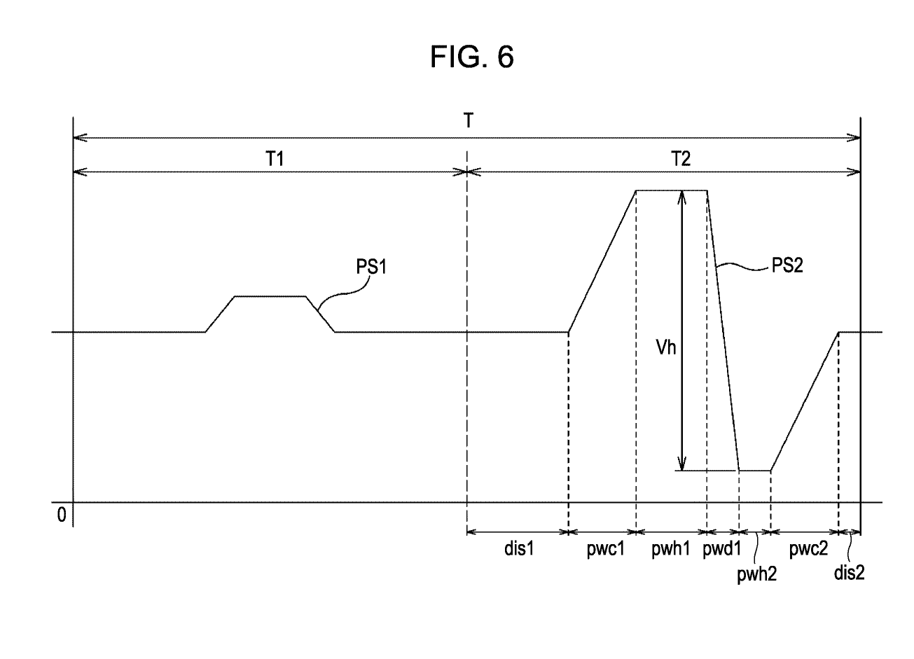

FIG. 6 is a view explaining the driving signal. In this embodiment, since six heads are provided, the first driving signal COM1 to the sixth driving signal COM6 are outputted as the driving signal. Further, in driving voltage setting processing which will be described later, since the second driving pulses PS2 in the first driving signal COM1 to the sixth driving signal COM6 are slightly different in amplitude, but almost the same in shape, here, the explanation of the driving signal is conducted taking the first driving signal COM1 as an example.

The first driving signal COM1 is repeatedly generated for every repetition period T. The period T which is a repetition period corresponds to a period during the transportation of the paper S by one pixel region. For example, in a case where print resolution in the transport direction is 360 dpi, the period T corresponds to the period in which the paper S is transported 1/360 inch. Then, on the basis of pixel data included in print data, the driving pulse PS1 or PS2 of each section which is included in the period T is applied to the piezo element PZT, so that a dot can be formed or not be formed in one pixel region.

The first driving signal COM1 has the first driving pulse PS1 which is generated in the section T1 in the repetition period, and the second driving pulse PS2. The first driving pulse PS1 is a minute vibration pulse, and is a driving pulse for minutely vibrating the ink face (ink meniscus) of the nozzle. In a case where this pulse is applied, ink is not ejected from the nozzle. On the other hand, the second driving pulse PS2 is a pulse for ink ejection, and is a driving pulse for ejecting ink from the nozzle. In a case where this pulse is applied, ink is ejected from the nozzle.

In the drawing, Vh is denoted as the amplitude of the second driving pulse PS2. If the amplitude is set to be large, an ink drop of a large size is ejected, and if the amplitude is set to be small, an ink drop of a small size is ejected. Accordingly, by correcting and setting the amplitude by a method which will be described later, it is possible to eject an ink drop of a desired size. In this way, it becomes possible to perform the printing of a desired density. Furthermore, in the following explanation, the amplitude Vh of the driving pulse for ejecting ink in this manner is called a driving voltage Vh.

Further, in the drawing, dis1, pwc1, pwh1, pwd1, pwh2, pwc2, and dis2 are indicated as time intervals in each section of the driving pulse PS2. As will be described later, it is possible to change the size of an ink drop not only by changing the amplitude Vh, but also by changing these periods. Accordingly, not only the amplitude of the driving pulse, but also each of these periods constituting the driving pulse corresponds to a parameter of the driving pulse.

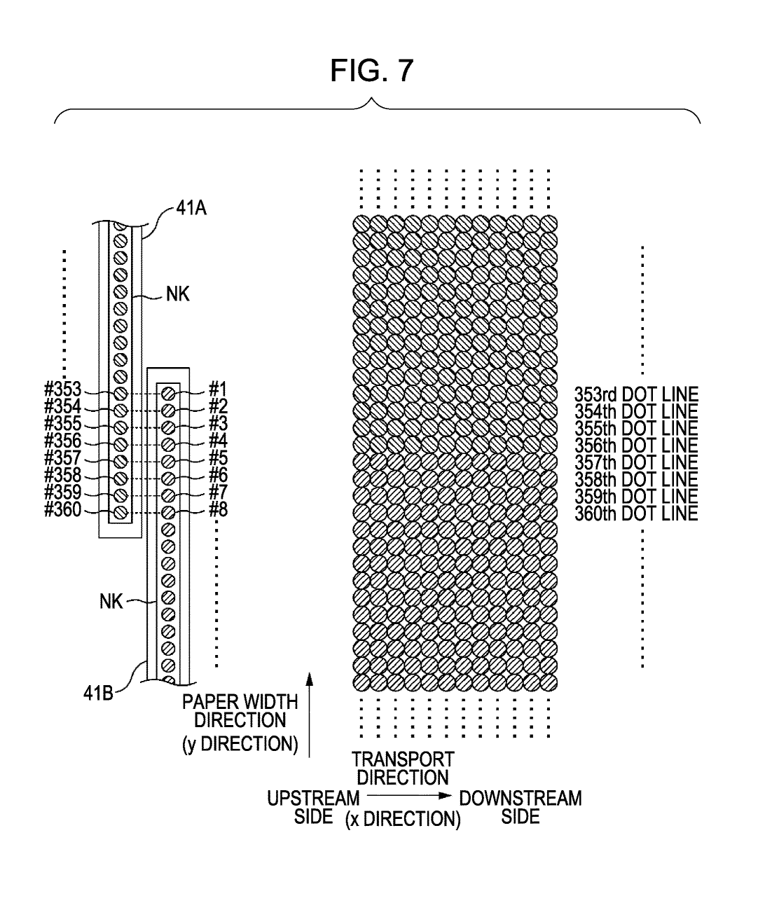

FIG. 7 is an explanatory view of the aspects of head arrangement and dot formation. Here, for simplification of explanation, only two heads (the first head 41A and the second head 41B) in the head unit 40 are shown. Further, for simplification of explanation, it is assumed that only the black ink nozzle row NK is provided in each head. In the following explanation, there is a case where the transport direction is called an “x direction” and the paper width direction is called a “y direction”.

The black ink nozzle row of each head is constituted of the nozzles arranged at 1/360 inch intervals in the paper width direction (y direction). The nozzle number is imparted to each of the nozzles in order from the upper side of the drawing.

Further, as an ink drop is intermittently discharged from each nozzle onto the paper S which is being transported, each nozzle forms a corresponding dot line on the paper. For example, nozzle #1 forms a first dot line on the paper. Each dot line is formed along the transport direction (x direction).

Nozzles #353 to #360 of the black ink nozzle row NK of the first head 41A and nozzles #1 to #8 of the black ink nozzle row NK of the second head 41B are disposed to correspond to each other in the transport direction. Thus, nozzles #353 to #356 of the first head 41A form a 353rd dot line to a 356th dot line, and nozzles #5 to #8 of the second head 41B form a 357th dot line to a 360th dot line. In this way, in the overlapping nozzles, a nozzle which forms a dot line is predetermined. That is, in the joining nozzles, a nozzle which forms a dot and a nozzle which does not form a dot are predetermined.

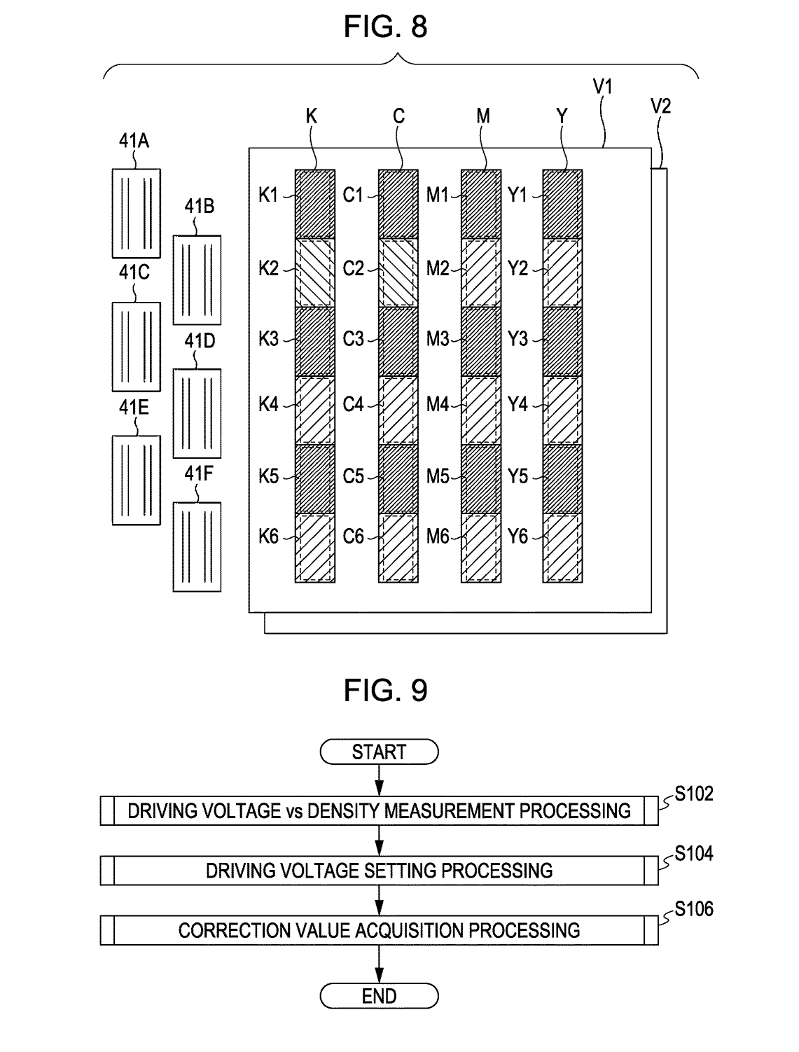

FIG. 8 is a view showing test patterns in this embodiment. In the drawing, the first head 41A to the sixth head 41F are shown. Here too, for the understanding of the positions of the nozzle rows, the nozzle rows which are not essentially visible from the upper side are shown to be visible. Additionally, in the drawing, two sheets of papers S are shown. On the paper S of one side, a driving voltage V1 is indicated so as to represent the formation of the test patterns when a common driving voltage V1 to the driving voltages Vh of the second driving pulses PS2 of the first driving signal COM1 to the sixth driving signal COM6 was set, and on the paper S of the other side, a driving voltage V2 is indicated so as to represent the formation of the test patterns when a driving voltage V2 was set.

Moreover, in the drawing, the test patterns which are formed for every ink color by each head are shown, and furthermore, as rectangular regions which are color-measured in the test patterns, K1 to K6, C1 to C6, M1 to M6, and Y1 to Y6 are indicated. The alphabets of the symbols represent the ink colors of the rectangular regions, and the numerals denoted next to the alphabets represent the number of the heads by which the test patterns are formed. For example, to the rectangular region of the test pattern of black formed by the first head 41A, the symbol of K1 is imparted.

With respect to the test patterns, the test patterns including Y1 to Y6 are first formed by ejecting ink from the yellow ink nozzle row NY while transporting the paper S in the transport direction. Next, the test patterns including M1 to M6 are formed by ejecting ink from the magenta ink nozzle row NM. Next, the test patterns including C1 to C6 are formed by ejecting ink from the cyan ink nozzle row NC. Next, the test patterns including K1 to K6 are formed by ejecting ink from the black ink nozzle row NK.

In the formation of the test patterns, the setting is made such that one dot is necessarily formed at a virtual pixel region in the medium. That is, as shown in FIG. 7, the dot lines which are formed by dots arranged in the transport direction are formed to be arranged at a nozzle pitch in the paper width direction.

Further, in the drawing, it is shown that despite the fact that a common driving voltage Vh to all of the driving signals COM1 to COM6 was set, the test patterns formed are different in density. This is due to the fact that due to the individual differences and the like between the respective heads, even in a case where the same driving voltage was applied, dots of different sizes are formed, and as a result, the test patterns which are different in density are formed.

FIG. 9 is a flow chart for explaining a driving voltage setting method in this embodiment. As described above, here, the first head 41A to the sixth head 41F are used. However, for ease of explanation, explanation is given with the number of heads reduced to three heads, the first head 41a to the third head 41C.

First, driving voltage versus density measurement processing is performed (S102). This driving voltage versus density measurement processing is the processing of deciding whether or not the relationship between the driving voltage which is applied to the head of the printer 1 used in this embodiment and the density of the test pattern formed has an almost linear relationship, before the driving voltage setting processing which will be described later. That is, it can be said that this driving voltage versus density measurement processing is the processing for confirming the linear relationship between the driving voltage and the density of the test pattern.

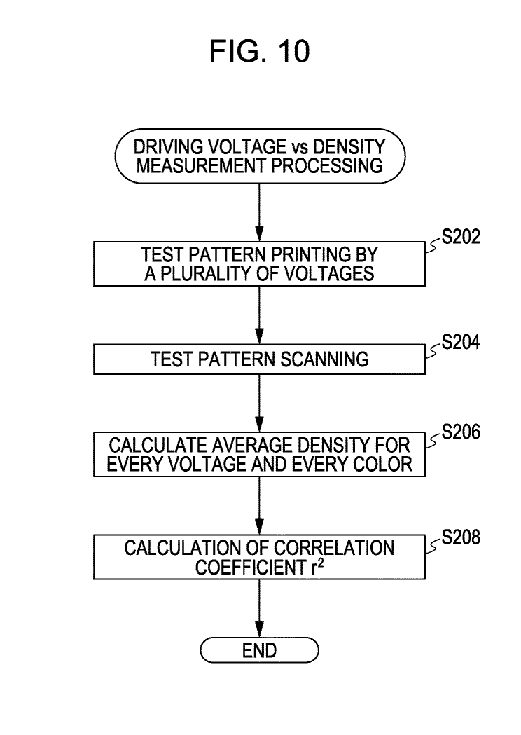

FIG. 10 is a flow chart for explaining the driving voltage versus density measurement processing. First, the above-mentioned test pattern for every driving voltage is formed by setting a plurality of voltages as the driving voltage Vh (S202). Here, as the driving voltage Vh, 20 V, 22 V, 24 V, 26 V, and 28 V are used. That is, the test patterns are printed on 5 sheets of papers S by these five driving voltages.

Next, these test patterns are read by the scanner 120 (S204). Thus, the brightness values of RGB color spaces (hereinafter referred to as an RGB value, or, individually, an R value, a G value, or a Y value) of the respective pixel regions of each test pattern are obtained.

Next, average densities for every driving voltage and every ink color are calculated (S206). As described above, the RGB value could be obtained by the reading of the test patterns by the scanner 120. Here, since it is necessary to acquire the densities of YMCK color spaces, color conversion processing from RGB to YMCK is performed. As a conversion equation, general conversion equations as shown below are used.

Y=(1−B/255−Kf)/(1−Kf)*255

M=(1−G/255−Kf)/(1−Kf)*255

C=(1−R/255−Kf)/(1−Kf)*255

K=Kf*255

### However, Kf=Min(1−R/255, 1−G/255, 1−B/255).

Min is a function which returns a minimum value in parenthesis.

In this way, a density value of 256 gradations in each pixel region can be obtained. Further, a conversion equation other than this may also be used.

Thus, a Y value, a M value, a C value, and a K value in each pixel region are obtained as a density. However, with respect to the rectangular region of each ink color, only a density of a corresponding ink color is referred to. For example, in the rectangular region K1, only the density of black K which was calculated by the above equation is referred to, and the density values of yellow Y, magenta M, and cyan C are ignored.

If a density in each pixel region is obtained, average densities for every driving voltage and every ink color are obtained. Here, the average density is an average density in each rectangular region surrounded by a broken line in FIG. 8. In this embodiment, since the scanner 120 is used for color measurement, it is possible to obtain a brightness value in a pixel region unit. However, here, by obtaining an average value of the rectangular region surrounded by a rectangle of a broken line, the reliability of an obtained density value becomes higher.

Specifically, for example, the average density of the rectangular region K1 (the region of black K obtained by the first head 41A) when the driving voltage Vh is 22 V is obtained. The average density is obtained by calculating the average of the densities of black K of all pixel regions within the rectangular region K1.

The calculation of such an average density is executed on each of K1 to K3, C1 to C3, M1 to M3, and Y1 to Y3. Similarly, also with respect to cases where the driving voltage Vh is 22 V, 24 V, 26V, and 28 V, the calculation of the average densities in these cases is executed.

Next, on the basis of the applied driving voltage and the obtained average density, the calculation of a correlation coefficient r² is executed (S208). The r value of the correlation coefficient r² can be calculated by the following formula.

$$r = \frac{n ( \sum xy ) - ( \sum x ) ( \sum y )}{\sqrt{[ n \sum {x}^{2} - {( \sum x )}^{2} ] [ n \sum {y}^{2} - {( \sum y )}^{2} ]}} \qquad Formula 1$$

Here, r² for every ink color is calculated with each driving voltage as x and an average density which is obtained correspondingly to this as y. As the value of the correlation coefficient r² is closer to 1, it has a linear correlation. However, here, in a case where the numerical value of approximately 0.97 or more was obtained, it is decided that the relationship between a driving voltage and the obtained density has linearity. Further, since the lower limit reference of the numerical value of r² for the decision of the linearity depends on the performance of the printer 1 required, the numerical value is not limited to 0.97 described above.

In this way, in the driving voltage versus density measurement processing, it is possible to obtain the numerical value for deciding the linearity of the relationship between a driving voltage and an average density. Then, if decision that the head of the printer 1 has linearity is made on the basis of the numerical value, driving voltage setting processing (S104) is then executed.

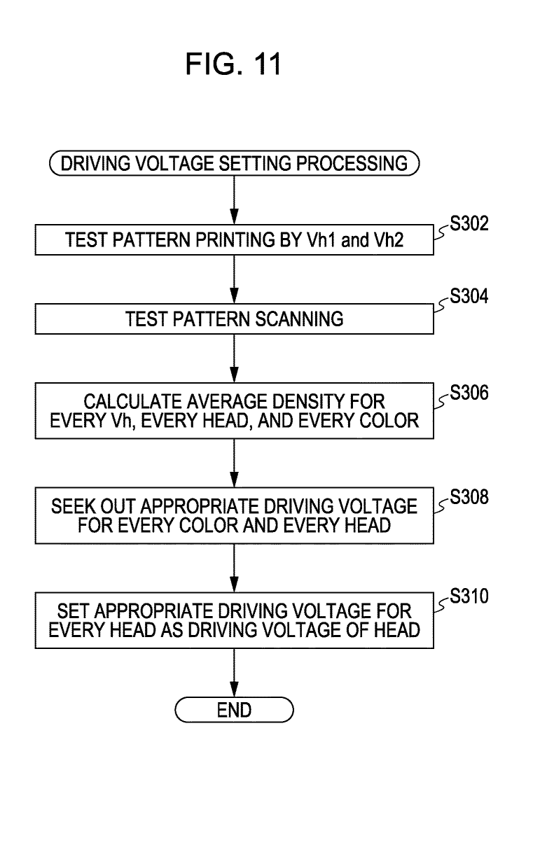

FIG. 11 is a flow chart for explaining the driving voltage setting processing. In the steps S302, S304, and S306 of the driving voltage setting processing, the driving voltage Vh is determined to be two voltages, Vh1 and Vh2, and approximately the same processing as S202, S204, and S206 in the driving voltage versus density measurement processing is executed.

First, in the driving voltage setting processing, the respective test patterns when the driving voltage was set to be Vh1 and Vh2 are formed (S302). The test patterns printed are the same as the test patterns shown in FIG. 8 described above. However, the test pattern when the driving voltage was set to be Vh1 (here, 22 V) is printed on one sheet of paper, and further, the test pattern when the driving voltage was set to be Vh2 (here, 25 V) is printed on another sheet of paper.

Next, the reading of the printed test patterns by the scanner is executed (S304). The reading is performed on two sheets, the test pattern when the driving voltage was set to be Vh1, and the test pattern when the driving voltage was set to be Vh2. Then, with respect to each of the same rectangular regions as those described above, the RGB values for every head and every ink color are acquired.

Next, average densities for every driving voltage and every ink color are calculated (S306). Here, the RGB values obtained at the step S304 are converted into YMCK values. Then, an average density for every rectangular region is obtained by the same method as the step S204.

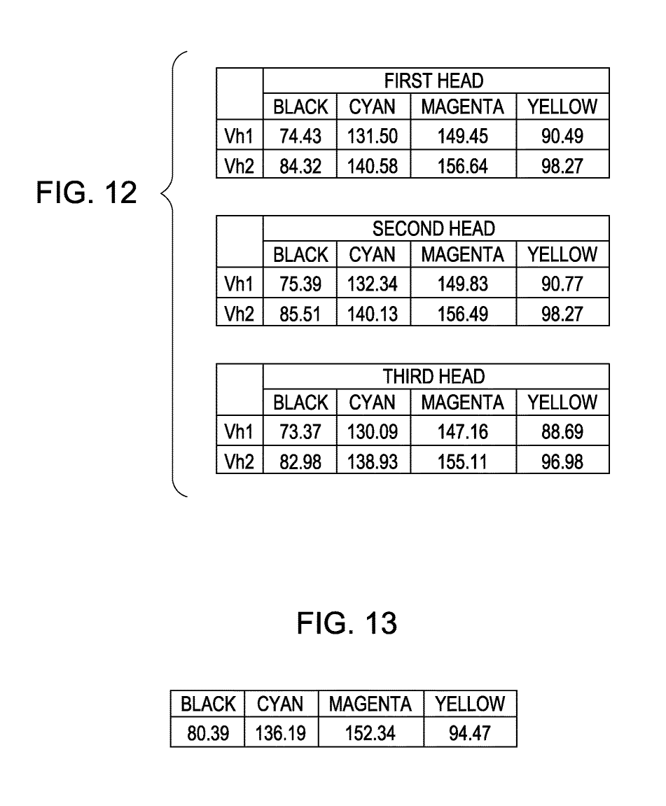

FIG. 12 is a table showing the average density obtained for every driving voltage in each ink color of each head. In the drawing, the average densities for every ink color of each head in the driving voltages Vh1 and Vh2 are shown. Here, as described above, for ease of explanation, the average densities are obtained with respect to the first head 41A to the third head 41C. Referring to the table, it is shown that when the driving voltage is low (Vh1), density difference is lower than when the driving voltage is high (Vh2).

Next, an appropriate driving voltage for every ink color of each head is sought out (S308). The appropriate driving voltage is to represent the necessary driving voltage for outputting a density which becomes a reference with respect to each ink color of each head. In order to seek out such an appropriate driving voltage, a reference density of each ink color is sought out in advance. The reference density is predetermined in accordance with the required specifications for performing color printing excellently balanced in terms of the color developing of each ink color, when performing color printing.

FIG. 13 is a table showing the reference density of each ink color. In this manner, an appropriate reference density value is determined for every ink color used. In the printer 1, the printing of such a reference density can be appropriately performed, so that specifications capable of realizing desired color printing are provided.

The appropriate driving voltage can be sought out by seeking out a driving voltage that provides the reference density. However, here, the previously obtained densities in two driving voltages Vh1 and Vh2 are linearly-interpolated, and the appropriate driving voltage is sought out from the linearly-interpolated density value. Here, the reason that the appropriate driving voltage can be sought out from the linearly-interpolated density value is because the linearity of a density in the driving voltage of the head in this embodiment is guaranteed in the driving voltage versus density measurement processing described above.

The expression of a linearly-interpolated line segment is obtained by a linear expression (y=ax+b). The coefficients a and b of the linear expression can be obtained by allying two linear equations when y is assigned to each density when each of the driving voltages Vh1 and Vh2 is x.

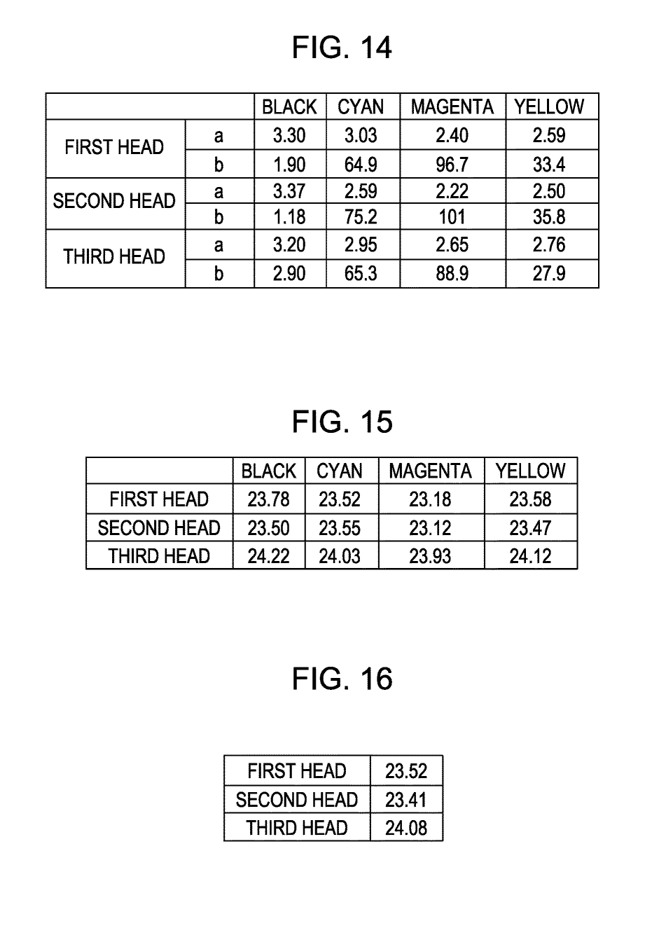

FIG. 14 is a table showing the obtained coefficients a and b of the linear expression. In the table, the coefficients a and b of each head in each ink color are shown. According to this table, for example, the linear expression when the ink color of the first head 41A is black K is expressed as y=3.30x+1.90.

Next, from the obtained linear expression, an appropriate driving voltage for every ink color of each head is obtained. The appropriate driving voltage can be obtained by evaluating an x value by assigning a reference density value to y of the linear expression. For example, as described above, since the linear expression of the first head 41A when an ink color is black K was y=3.30x+1.90, if the x value is evaluated by assigning the reference density, 80.39, of black K to y, an appropriate driving voltage, 23.78, is obtained. The appropriate driving voltage of each head in each ink color can be similarly obtained.

FIG. 15 is a table showing the appropriate driving voltage for every ink color of each head. In this manner, in the respective heads, the required driving voltages for outputting the same reference density are slightly different due to individual difference.

Next, the average value of the appropriate driving voltage for every head is set as the driving voltage of the head (S310). For example, in the case of the first head 41A, the average of the appropriate driving voltage, 23.78, of black of the first head 41A, the appropriate driving voltage, 23.52, of cyan, the appropriate driving voltage, 23.18, of magenta, and the appropriate driving voltage, 23.58, of yellow is calculated.

FIG. 16 is a table showing the appropriate driving voltage of each head. The voltage for each head thus obtained is set for each head. The reason that average value of the appropriate driving voltages for all ink colors of the head is set as a driving voltage with respect to each head is because a driving signal is supplied in a unit of a head. For example, to the first head 41A, the first driving signal COM1 is supplied, and the first driving signal COM1 is used in common in the yellow ink nozzle row NY, the magenta ink nozzle row NM, the cyan ink nozzle row NC, and the black ink nozzle row NK. Therefore, by obtaining the average of the appropriate driving voltages of these ink colors, an almost appropriate driving voltage for any ink color is obtained, so that difference in density between the heads is reduced.

Moreover, if the kind of medium is changed, the color-developing of the ink also varies. Accordingly, in the case that different media are used, the above-described embodiment may also be implemented on different kinds of media so as to obtain an appropriate driving signal for every medium.

In the meantime, here, the size of a dot formed was one type. However, in a case where dots having a plurality of sizes can be formed, it is also acceptable that the test pattern is prepared for every dot of each size and the driving voltage of a driving pulse for forming the dot of each size is set.

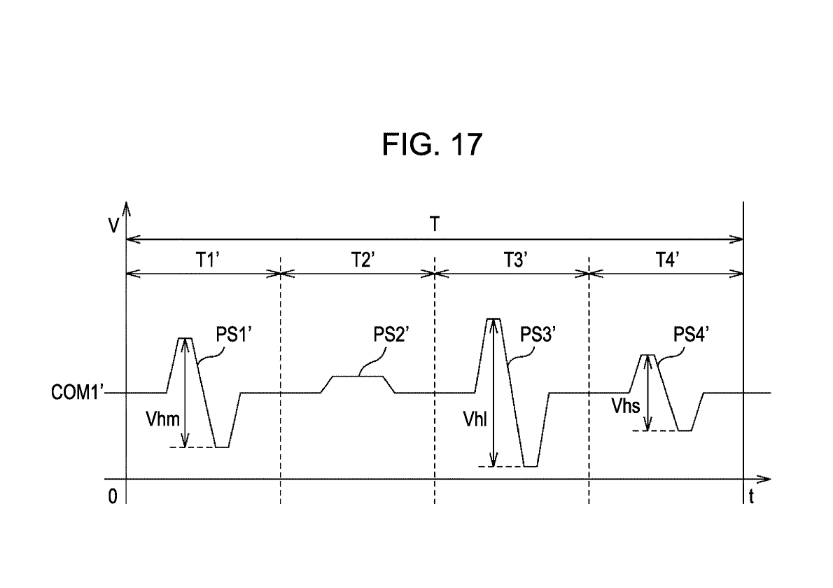

FIG. 17 is a view showing one example of a driving signal when dots having a plurality of sizes can be formed. Here too, a first driving signal COM1′ to a sixth driving signal COM6′ are outputted, and each driving signal is supplied to a corresponding head. Similarly to the above description, since the amplitudes of the driving pulses are slightly different among the driving signals, but the shapes of the respective driving signals are approximately the same, only the first driving signal COM1′ is explained.

The first driving signal COM1′ includes a first driving pulse PS1′ for forming a middle-size dot, a second driving pulse PS2′ for minutely vibrating an ink meniscus, a third driving pulse PS3′ for forming a large dot, and a fourth driving pulse PS4′ for forming a small dot. Then, when ink is not ejected from the nozzle, only the second driving pulse PS2′ is applied to the piezo element PZT. In addition, when ink for forming a small dot is ejected from the nozzle, only the fourth driving pulse PS4′ is applied to the piezo element PZT. Further, when ink for forming a middle-size dot is ejected from the nozzle, only the first driving pulse PS1′ is applied to the piezo element PZT. Moreover, when ink for forming a large dot is ejected from the nozzle, only the third driving pulse PS3′ is applied to the piezo element PZT.

In the drawing, the driving voltage Vhm of the first driving pulse PS l′, the driving voltage Vh1 of the third driving pulse PS3′, and the driving voltage Vhs of the fourth driving pulse PS4′ are shown. The magnitude relation among these voltages is Vh1>Vhm>Vhs. That is, as the driving voltage is larger, it becomes possible to form the larger dot.

In this way, in a case where a small dot, a middle-size dot, and a large dot can be formed, the reference densities as shown in FIG. 13 are prepared for three dots, a small dot, a middle-size dot, and a large dot. Then, the same method as described above is applied to each reference density. That is, Vhs is adjusted so as to provide the reference density for a small dot, Vhm is adjusted so as to provide the reference density for a middle-size dot, and Vh1 is adjusted so as to provide the reference density for a large dot.

In this way, in the printer capable of forming the dots of a plurality sizes, difference in density between the heads can be reduced.

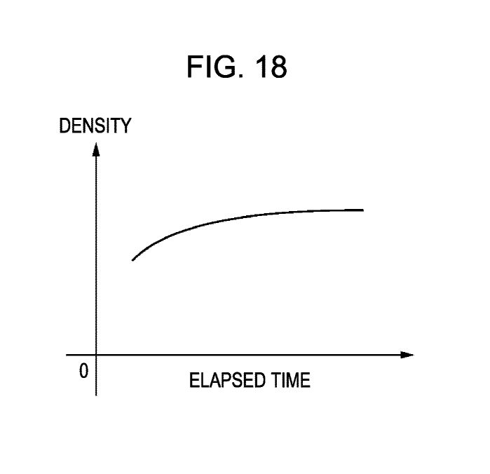

FIG. 18 is a graph showing the relationship between the elapsed time and density. Essentially, when performing the color measurement of density, it is necessary to perform the color measurement after sufficient drying of the ink. However, as shown in the drawing, according to the ink used, there is a case where density rises with the passage of time from the formation of a dot on a medium. It is also acceptable to perform the color measurement of density after sufficient drying of the ink. However, in such a case, waiting time is required until the color measurement.

Accordingly, in such a case, it is also acceptable to acquire in advance the relationship between the elapsed time and density, as shown in the drawing. Then, it is also acceptable to acquire the density to be originally measured, on the basis of the time after the printing of a test pattern and until the measurement of density, and the measured density.

In this way, difference in density between the heads can be reduced. However, since the average value of the appropriate driving voltages for all ink colors for each head is set as an appropriate voltage of the head, as described above, a case where density difference is generated can occur, although the difference is an extremely small amount. Since such density difference occurs in a unit of a head, if density correction in unit of a row region composed of the pixel regions arranged in the transport direction is performed, difference in density between the heads can be further reduced. The method of performing density correction in a unit of a row region composed of the pixel regions arranged in the transport direction is explained below.

### Processing by Printer Driver

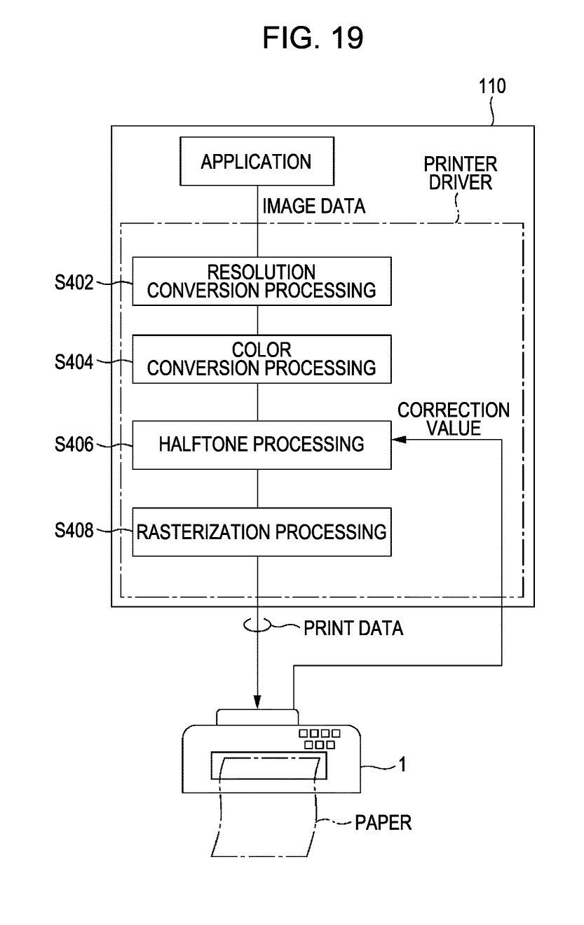

FIG. 19 is an explanatory view of processing by the printer driver. The processing by the printer driver is explained below with reference to the drawing.

The print image data is generated by executing resolution conversion processing (S402), color conversion processing (S404), halftone processing (S406), and rasterization processing (S408) by the printer driver, as shown in the drawing.

First, in the resolution conversion processing, the resolution of RGB image data obtained by the execution of an application program is converted into print resolution corresponding to designated image quality. Next, in the color conversion processing, the RGB image data with converted resolution is converted into CMYK image data. Here, the CMYK image data means the image data for each color of cyan (C), magenta (M), yellow (Y), and black (K). Further, a plurality of pixel data constituting the CMYK image data are respectively expressed as gradation values of 256 steps. The gradation value is determined on the basis of the RGB image data and hereinafter also called a command gradation value.

Next, in the halftone processing, the gradation values of a multistep represented by pixel data constituting the image data are converted into the dot gradation values of a small step which can be expressed in the printer 1. Here, the gradation values of 256 steps represented by the pixel data are converted into dot gradation values of two steps. Specifically, they are converted into two steps, the absence of a dot, which corresponds to a dot gradation value [00] and the presence of a dot, which corresponds to a dot gradation value [01].

In addition, in a case where dots of a plurality of sizes can be formed, for example, it is also acceptable to perform conversion into four steps, the absence of a dot, which corresponds to a dot gradation value [00], the formation of a small dot, which corresponds to a dot gradation value [01], the formation of a middle-size dot, which corresponds to a dot gradation value [10], and the formation of a large dot, which corresponds to a dot gradation value [11].

Thereafter, with respect to the size of each dot, a dot generation rate is determined, and then, by using a dither method, etc., pixel data is generated such that the printer 1 distributes and forms dots.

Next, in the rasterization processing, with respect to the image data obtained in the halftone processing, the data of each dot is changed in order of data to be transmitted to the printer 1. Then, the data subjected to the rasterization processing is transmitted as a portion of the print data.

### Concerning Density Unevenness

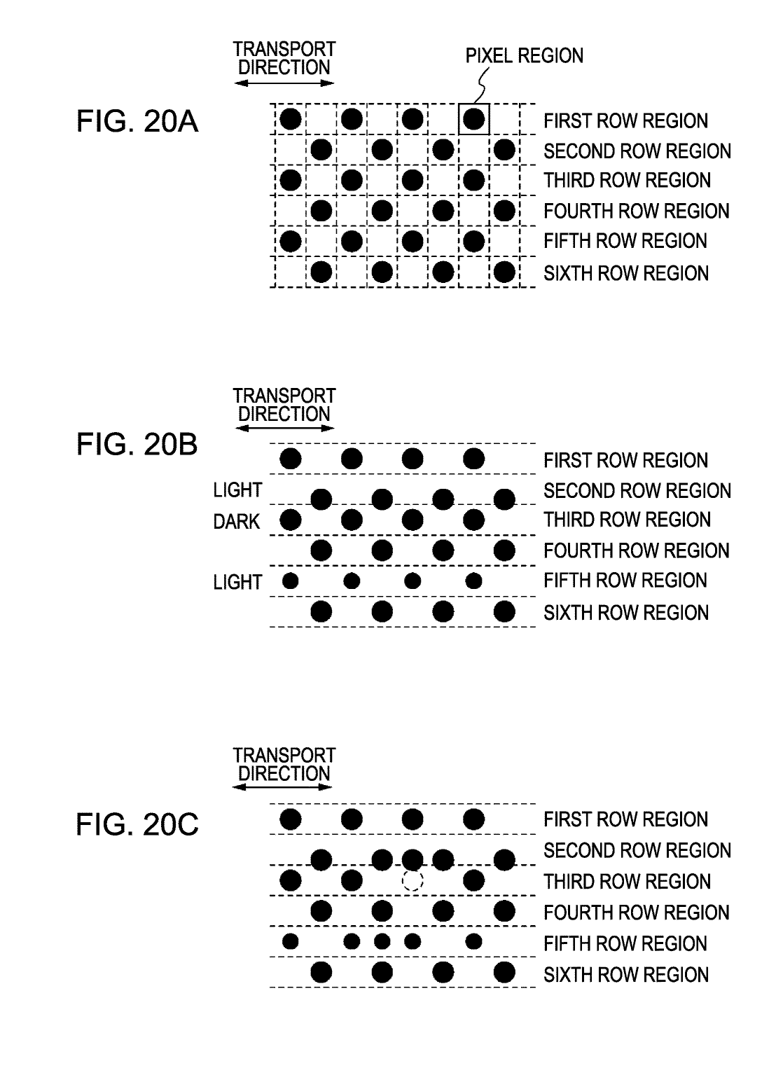

FIG. 20A is an explanatory view of an aspect when dots were ideally formed. That dots are ideally formed means that an ink drop lands at the center position of the pixel region and the ink drop spreads on the paper S, so that a dot is formed at the pixel region. If each dot is exactly formed at each pixel region, a dot line (dot row with dots arranged in the transport direction) is exactly formed at the row region.

FIG. 20B is an explanatory view when density unevenness was generated. The dot line formed at the second row region is formed biased toward the third row region due to the variation of the flight directions of the ink drops discharged from the nozzles. As a result, the second row region becomes lighter, and the third row region becomes darker. Further, the amount of ink of the ink drop discharged at the fifth row region is smaller than the prescribed amount of ink, so that the dots formed at the fifth row region becomes smaller. As a result, the fifth row region becomes lighter.

If the printed image composed of the raster lines which are different in shading in this manner is macroscopically viewed, density unevenness of a stripe shape along the transport direction is visible. The density unevenness causes the lowering of the image quality of the printed image.

As measures to suppress the above-mentioned density unevenness, correcting the gradation value (command gradation value) of the image data can be considered. That is, with respect to the row region which is likely to be darkly (lightly) visible, the gradation values of the pixels corresponding to a unit region constituting the row region are corrected such that the row region is lightly (darkly) formed. For this, a density correction value H is calculated which corrects the gradation value of the image data for every raster line. The density correction value H is a value reflecting the density unevenness characteristic of the printer 1.

FIG. 20C is a view showing an aspect in which the generation of density unevenness was suppressed. If the density correction value H for every raster line is calculated, during the execution of the halftone processing, by the printer driver, processing is performed which corrects the gradation value of the pixel data for every raster line on the basis of the density correction value H. If each dot line is formed using the gradation value corrected by the correction processing, the density of a corresponding raster line is corrected, so that, as shown in FIG. 20C, the generation of the density unevenness in the printed image is suppressed.

For example, in FIG. 20C, the gradation values of the pixel data of the pixels corresponding to each row region are corrected such that the dot generation rates of the second and fifth row regions which are lightly visible is increased and the dot generation rate of the third row region which is darkly visible is lowered. In this manner, the dot generation rate of the raster line of each row region is changed, so that the density of the image piece of the row region is corrected, whereby the density unevenness of the entirety of the printed image is suppressed.

### Concerning Calculation of Density Correction Value H

Next, the processing of calculating the density correction value H for every raster line (hereinafter also referred to as correction value acquisition processing) is explained. The correction value acquisition processing is performed under a correction value calculation system, for example, in the inspection line of the manufacturing plant of the printer 1. The correction value calculation system is a system for calculating the density correction value H corresponding to the density unevenness characteristic of the printer 1 and has the same configuration as the above-mentioned printing system 100. That is, the correction value calculation system has a printer 1, a computer 110, and a scanner 120 (for convenience, they are denoted by the same reference numerals as the case of the printing system 100).

The printer 1 is a target instrument of the correction value acquisition processing, and in order to print an image that does not have density unevenness by using the printer 1, the density correction value H for the printer 1 is calculated in the correction value acquisition processing. In the computer 110 disposed at the inspection line, there is installed a correction value calculation program by which the computer 110 executes the correction value acquisition processing.

### Concerning Correction Value Acquisition Processing

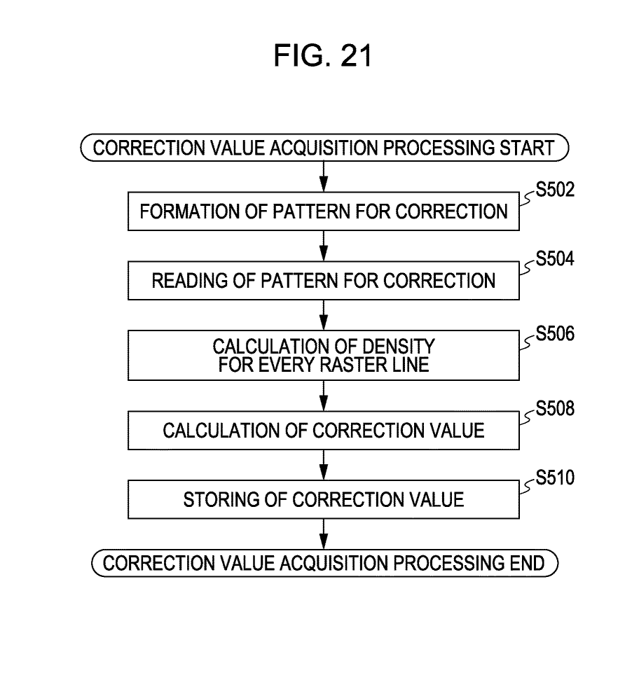

FIG. 21 is a view showing the flow of the correction value acquisition processing. In the case of targeting the printer 1 capable of performing multicolored printing, the correction value acquisition processing related to each ink color is carried out by the same procedure. In the following explanation, the correction value acquisition processing related to one ink color (for example, black) is explained.

First, the computer 110 transmits print data to the printer 1, so that the printer 1 forms a pattern CP for correction on the paper S by the same procedure as the above-described printing operation (S502).

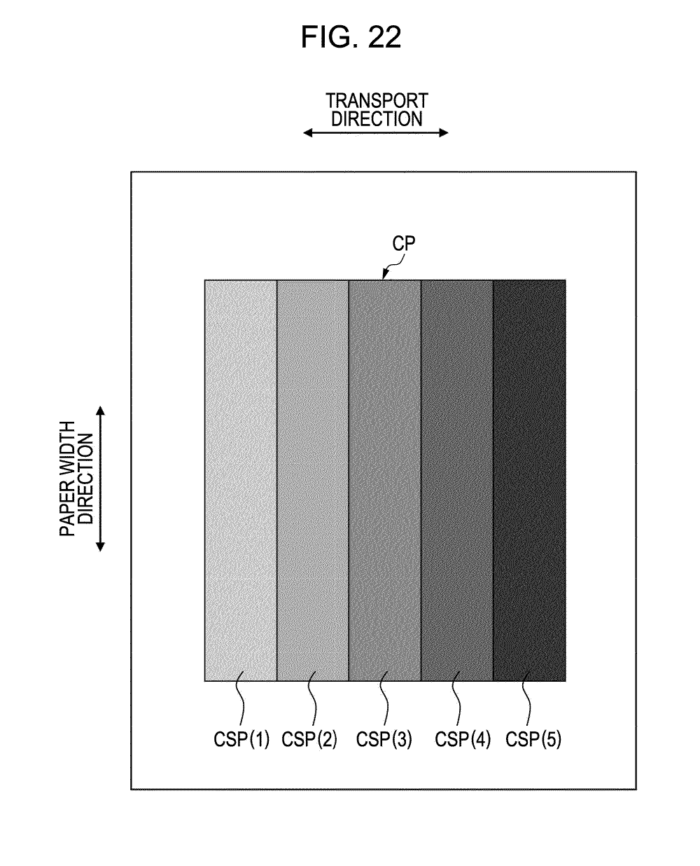

FIG. 22 is an explanatory view of the pattern CP for correction. The pattern CP for correction is formed into sub-patterns CSP having five kinds of densities, as shown in FIG. 22.

Each sub-pattern CSP is a band-like pattern and is constituted by arranging a plurality of raster lines, which extend in the paper width direction, in the transport direction. Further, each sub-pattern CSP is generated from the image data of a constant gradation value (command gradation value), and the respective sub-patterns have densities which become darker in sequence from the left sub-pattern CSP, as shown in FIG. 22. Specifically, the sub-patterns have the densities of 15%, 30%, 45%, 60%, and 85% in sequence from the left. Hereinafter, the command gradation value of the sub-pattern CSP of 15% density is denoted by Sa, the command gradation value of the sub-pattern CSP of 30% density is denoted by Sb, the command gradation value of the sub-pattern CSP of 45% density is denoted by Sc, the command gradation value of the sub-pattern CSP of 60% density is denoted by Sd, and the command gradation value of the sub-pattern CSP of 85% density is denoted by Se. In addition, for example, the sub-pattern CSP formed by the command gradation value Sa is denoted by CSP(1), as shown in FIG. 22. Similarly, the sub-patterns CSP formed by the command gradation values Sb, Sc, Sd, and Se are denoted by CSP(2), CSP(3), CSP(4), and CSP(5), respectively.

Next, an inspector sets the paper S with the pattern CP for correction formed, on the scanner 120. Then, the computer 110 makes the scanner 120 read the pattern CP for correction and acquires the results (S504). The scanner 120 has three sensors corresponding to R (red), G (green), and B (blue), as described above, irradiates the pattern CP for correction with light, and detects the reflected light by each sensor. Additionally, the computer 110 performs adjustment such that on the image data from which the pattern for correction was read, the number of pixel rows with pixels arranged in a direction corresponding to the transport direction is the same as the number of raster lines (the number of row regions) constituting the pattern for correction. That is, the pixel row and the row region, which are read by the scanner 120, are corresponded one-to-one to each other. Then, the average value of the read gradation values expressed by the respective pixels of the pixel row corresponding to a certain row region is used as the read gradation value of the row region.

Next, the computer 110 calculates the density for every raster line (in other words, every row region) of each sub-pattern CSP on the basis of the read gradation value acquired by the scanner 120 (S506). Hereinafter, the density calculated on the basis of the read gradation value is also referred to as a calculated density.

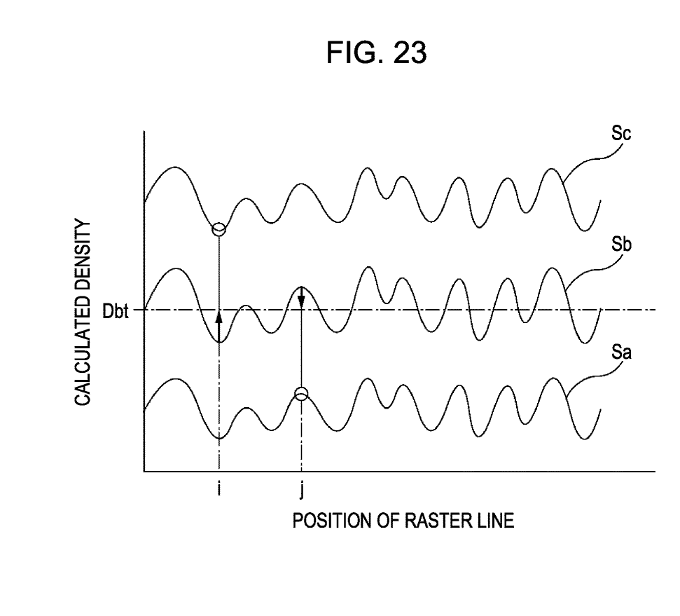

FIG. 23 is a graph showing the calculated density for every raster line with respect to the sub-patterns CSP in which the command gradation values are Sa, Sb, and Sc. The horizontal axis of FIG. 23 represents the position of a raster line and the vertical axis represents the magnitude of a calculated density. As shown in FIG. 23, shading occurs in each sub-pattern CSP for every raster line, despite the fact that the respective sub-patterns are formed by the same command gradation value. The difference in shading of the raster lines is the cause of the density unevenness of the printed image.

Next, the computer 110 calculates the density correction value H for every raster line (S508). Further, the density correction value H is calculated for every command gradation value. Hereinafter, the density correction values H calculated with respect to the command gradation values Sa, Sb, Sc, Sd, and Se are denoted by Ha, Hb, Hc, Hd, and He, respectively. In order to explain the calculation procedure of the density correction value H, a procedure of calculating the density correction value Hb for correcting the command gradation value Sb such that the calculated density for every raster line of the sub-pattern CSP(2) of the command gradation value Sb becomes constant is taken and explained as an example. In the procedure, for example, the average value Dbt of the calculated densities of all raster lines in the sub-pattern CSP(2) of the command gradation value Sb is determined as a target density of the command gradation value Sb, In FIG. 23, in an i-th raster line in which a calculated density is lighter than the target density Dbt, the command gradation value Sb is corrected so as to make the density darker. On the other hand, in a j-th raster line in which a calculated density is darker than the target density Dbt, the command gradation value Sb is corrected so as to make the density lighter.

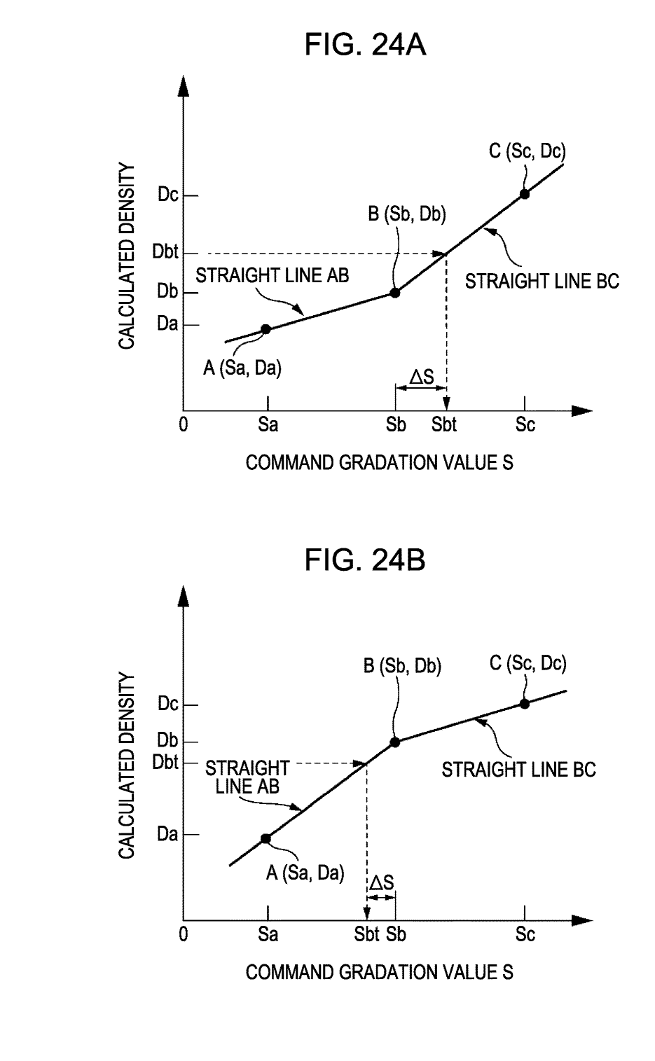

FIG. 24A is an explanatory view of the procedure of calculating the density correction value Hb for correcting the command gradation value Sb with respect to the i-th raster line, and FIG. 24B is an explanatory view of the procedure of calculating the density correction value Hb for correcting the command gradation value Sb with respect to the j-th raster line. The horizontal axes of FIGS. 24A and 24B represent the magnitude of the command gradation value, and the vertical axes represent the calculated density.

The density correction value Hb for the command gradation value Sb of the i-th raster line is calculated on the basis of the calculated density Db of the i-th raster line in the sub-pattern CSP(2) of the command gradation value Sb shown in FIG. 24A, and the calculated density Dc of the i-th raster line in the sub-pattern CSP(3) of the command gradation value Sc. More specifically, in the sub-pattern CSP(2) of the command gradation value Sb, the calculated density Db of the i-th raster line is smaller than the target density Dbt. In other words, the density of the i-th raster line is lighter than an average density. If it is desired to form the i-th raster line such that the calculated density Db of the i-th raster line becomes the same as the target density Dbt, the gradation value, namely, the command gradation value Sb, of the pixel data corresponding to the i-th raster line is corrected up to a target command gradation value Sbt which is calculated by the following equation (1), by using a straight-line approximation from a correspondence relation (Sb,Db), (Sc,Dc) between the command gradation value and the calculated density in the i-th raster line, as shown in FIG. 24A.

Sbt=Sb+(Sc−Sb)×{(Dbt−Db)/(Dc−Db)} (1)

Then, from the command gradation value Sb and the target command gradation value Sbt, the density correction value H for correcting the command gradation value Sb with respect to the i-th raster line is obtained by the following equation (2).

Hb=ΔS/Sb=(Sbt−Sb)/Sb (2)

On the other hand, the density correction value Hb for the command gradation value Sb of the j-th raster line is calculated on the basis of the calculated density Db of the j-th raster line in the sub-pattern CSP(2) of the command gradation value Sb shown in FIG. 24B, and the calculated density Da of the j-th raster line in the sub-pattern CSP(1) of the command gradation value Sa. Specifically, in the sub-pattern CSP(2) of the command gradation value Sb, the calculated density Db of the j-th raster line is larger than the target density Dbt. If it is desired to form the j-th raster line such that the calculated density Db of the j-th raster line becomes the same as the target density Dbt, the command gradation value Sb of the j-th raster line is corrected up to a target command gradation value Sbt which is calculated by the following equation (3), by using a straight-line approximation from a correspondence relation (Sa,Da), (Sb,Db) between the command gradation value and the calculated density in the j-th raster line, as shown in FIG. 24B.

Sbt=Sb+(Sb−Sa)×{(Dbt−Db)/(Db−Da)} (3)

Then, the density correction value Hb for correcting the command gradation value Sb with respect to the j-th raster line is obtained by the above equation (2).

In this manner, the computer 110 calculates the density correction value Hb for the command gradation value Sb for every raster line. Similarly, the density correction values Ha, Hc, Hd, and He for the command gradation values Sa, Sc, Sd, and Se are respectively calculated for every raster line. Also with respect to other ink colors, the density correction values Ha to He for the command gradation values Sa to Se are respectively calculated for every raster line.

Thereafter, the computer 110 transmits the data of the density correction vale H to the printer 1, thereby storing the data in the memory 63 of the printer 1 (S510).

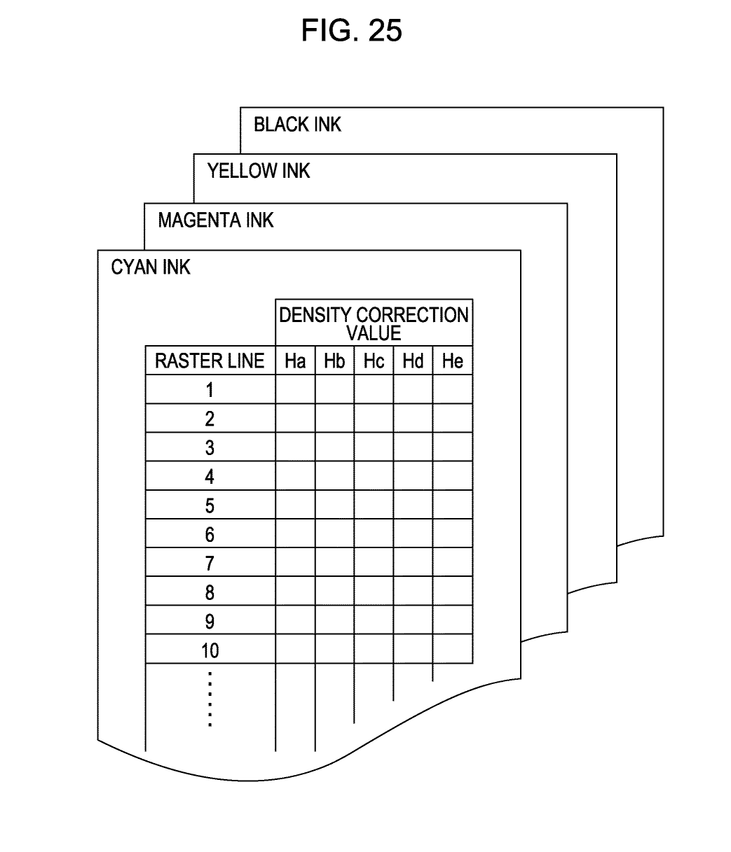

FIG. 25 is a view showing correction value tables stored in the memory 63. As a result, in the memory 63 of the printer 1, the correction value tables shown in FIG. 25 are prepared which organized the density correction values Ha to He for five command gradation values Sa to Se for every raster line.

Further, as shown in FIG. 25, the correction value tables are separately prepared corresponding to each of the ink colors. As a result, the correction value tables for four colors, C, M, Y, and K, are prepared. The correction value tables are referred to by the printer driver in order to correct the gradation value of each of the raster lines constituting the image data of an image when printing the image by using the printer 1.

In this embodiment, a density is measured for every raster line corresponding to a pixel row on a piece of paper, and on the basis of the measured density, a correction value for correcting a gradation value is obtained. In this way, it is possible to perform density correction for every raster line. Then, it is possible to suppress the generation of color unevenness on a piece of paper.

### Print Processing

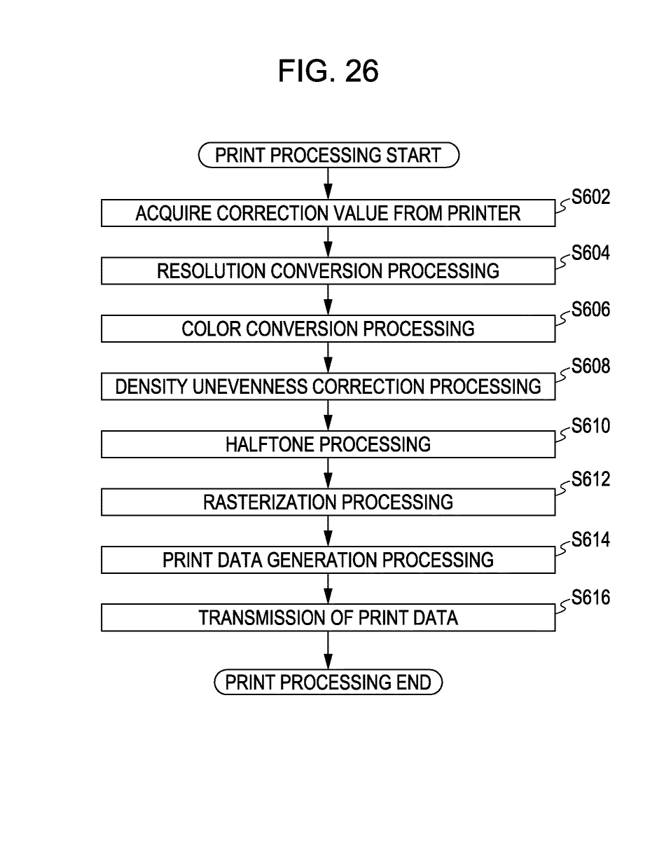

FIG. 26 is a flow chart of print processing which the printer driver performs under the direction of a user. A user who purchases the printer 1 installs a printer driver stored in a CD-ROM included in the printer 1 (or a printer driver downloaded from the home page of a printer manufacturer), in a computer. The printer driver is provided with codes for executing each processing in the drawing in a computer. Additionally, the user connects the printer 1 to the computer.

First, the printer driver acquires correction value tables (referring to FIG. 25) stored in a memory of the printer 1 from the printer 1 (S602).

When a user has instructed printing through an application program, the printer driver is called out, image data (print image data) which is a print target is received from the application program, and with respect to the print image data, resolution conversion processing is performed (S604). The resolution conversion processing is the processing of converting the image data (such as text data or image data) into resolution (print resolution) at the time of printing on a piece of paper. Here, the print resolution is 360 dpi×360 dpi, and each pixel data after the resolution conversion processing is data of 256 gradations which are expressed by RGB color spaces.

Next, the print driver performs color conversion processing (S606). The color conversion processing is the processing of converting the image data in accordance with the color space of the ink color of the printer 1. Here, the image data (256 gradations) of RGB color spaces is converted into the image data (256 gradations) of CMYK color spaces.

Thus, the image data of the CMYK color spaces of 256 gradations are obtained. On the other hand, in the following explanation, for simplification of explanation, the image data of a black plane among the image data of the CMYK color spaces is explained.

Next, the printer driver performs density unevenness correction processing (S608). The density unevenness correction processing is the processing of correcting each of the gradation values of the pixel data belonging to each pixel row on the basis of a correction value of every pixel row (corresponding to a raster line) on a piece of paper.

For example, the printer driver of the computer 110 of a user corrects the gradation value (hereinafter, the gradation value before correction is denoted by Sin) of each pixel data on the basis of the density correction value H of the raster line to which the pixel data correspond (hereinafter, the gradation value after correction is denoted by Sout).

Specifically, if the gradation value Sin of a certain raster line is the same as any of the command gradation values Sa, Sb, Sc, Sd, and Se, the density correction value H stored in the memory of the computer 110 can be used as it is. For example, if the gradation value Sin of the pixel data is equal to Sb, the gradation value after correction, Sout, can be obtained by the following equation.

Sout=Sb×(1+Hb)

On the other hand, in a case where the gradation value of the pixel data is different from the command gradation values Sa, Sb, Sc, Sd, and Se, a correction value is calculated on the basis of interpolation which uses the density correction value of the command gradation value of the surroundings. For example, in a case where the command gradation value Sin is a value between the command gradation value Sb and the command gradation value Sc, if the correction value calculated by linear interpolation which uses the density correction value Hb of the command gradation value Sb and the density correction value Hc of the command gradation value Sc is H′, the gradation value after correction, Sout, of the command gradation value Sin can be obtained by the following equation.

Sout=Sin×(1+H′)

In this way, the density correction processing is performed.

After the density unevenness correction processing, the printer driver performs halftone processing. The halftone processing is the processing of converting the data of the high gradation number into the data of the low gradation number. Here, the print image data of 256 gradations is converted into the print image data of 2 gradations which the printer 1 can express. As a halftone processing method, there is known a dither method, etc., and also in this embodiment, such halftone processing is performed.

In this embodiment, the printer driver performs the halftone processing on the pixel data subjected to the density unevenness correction processing. As a result, since the gradation value of the pixel data of a portion which is likely to be darkly visible is corrected so as to become lower, the dot generation rate of the portion is lowered. On the contrary, in a portion which is likely to be lightly visible, the dot generation rate is increased.

Next, the printer driver performs rasterization processing (S612). The rasterization processing is the processing of changing the alignment sequence of the pixel data on the print image data into the data sequence to be transmitted to the printer 1. Thereafter, the printer driver generates print data by adding control data for controlling the printer 1 to the pixel data (S614) and transmits the print data to the printer 1 (S616).

The printer 1 performs printing operation in accordance with the received print data. Specifically, the controller 60 of the printer 1 controls the transport unit 20 and the like in accordance with the control data of the received print data, and the head unit 40 in accordance with the pixel data of the received print data, thereby discharging ink from each nozzle. If the printer 1 performs the printing processing on the basis of the print data thus generated, the dot generation rate of each raster line is changed, so that the density of the image piece of the row region on the paper is corrected, whereby the density unevenness of the printed image is suppressed.

### Other Embodiments

In the above-described embodiment, as the fluid ejecting apparatus, the printer 1 has been explained. However, the invention is not to be limited thereto, but can also be embodied in a fluid ejecting apparatus which ejects or discharges fluid (liquid, liquid-form body with the particles of a functional material dispersed, or fluid-form body such as gel) other than ink. For example, the same technology as the above-described embodiment may also be applied to various apparatuses to which ink jet technology is applied, such as a color filter manufacturing apparatus, a dyeing apparatus, a micro-fabrication apparatus, a semiconductor manufacturing apparatus, a surface fabrication apparatus, a three-dimensional modeling device, a gas vaporization apparatus, an organic EL manufacturing apparatus (in particular, a high molecule EL manufacturing apparatus), a display manufacturing apparatus, a film formation apparatus, a DNA chip manufacturing apparatus. Further, the methods or manufacturing methods of these are also in the category of the application range.

The above-described embodiment is to facilitate understanding of the invention and the invention should not be construed as being limited thereto. The invention can be modified or improved without departing from the purpose of the invention, and it is also needless to say that the equivalents thereto are included in the invention.

### Regarding Head

As a method of ejecting ink as in the above-described embodiment, it is possible to eject ink by using a piezoelectric element. However, a method of ejecting liquid is not to be limited to this, but, for example, it is also acceptable to use another method such as a method of generating bubbles in a nozzle by heat.

What is claimed is:

1. A manufacturing method of a fluid ejecting apparatus comprising:
forming first and second test patterns by ejecting fluid from first and second nozzle rows which intersect with a relative movement direction of a medium, wherein the first nozzle row forms the first test pattern by ejecting the fluid in accordance with a first driving pulse and the second nozzle row forms the second test pattern by ejecting the fluid in accordance with a second driving pulse;
measuring the density of the first test pattern and the density of the second test pattern; and
correcting a parameter of the first driving pulse and a parameter of the second driving pulse such that the density of the first test pattern and the density of the second test pattern become a common target density.

2. The manufacturing method of a fluid ejecting apparatus according to claim 1, wherein the parameter of the first driving pulse and the parameter of the second driving pulse are the amplitude values of the voltages of the respective driving pulses.

3. The manufacturing method of a fluid ejecting apparatus according to claim 1, wherein the first test pattern is formed in a plurality of numbers by varying the parameter of the first driving pulse,
the second test pattern is formed in a plurality of numbers by varying the parameter of the second driving pulse,
the parameter of the first driving pulse is corrected such that the density of the first test pattern which the first nozzle row forms becomes a reference density, on the basis of a value linearly-interpolated based on the densities of the plurality of first test patterns which were formed, and
the parameter of the second driving pulse is corrected such that the density of the second test pattern which the second nozzle row forms becomes the reference density, on the basis of a value linearly-interpolated based on the densities of the plurality of second test patterns which were formed.

4. The manufacturing method of a fluid ejecting apparatus according to claim 1, wherein the first test pattern is a test pattern in which dots are formed at all pixels by the first nozzle row, and
the second test pattern is a test pattern in which dots are formed at all pixels by the second nozzle row.

5. The manufacturing method of a fluid ejecting apparatus according to claim 1, wherein
(A) in the formation of the first test pattern and the second test pattern,
the first nozzle row is one among a plurality of first nozzle row groups which are provided in a first head, the respective nozzle rows of the first nozzle row group form the first test patterns by ejecting fluid of different colors in accordance with the first driving pulse,
the second nozzle row is one among a plurality of second nozzle row groups which are provided in a second head, and the respective nozzle rows of the second nozzle row group form the second test patterns by ejecting fluid of different colors in accordance with the second driving pulse,
(B) in the measurement of the density of the first test pattern and the density of the second test pattern,
the densities of the first and second test patterns related to each color of the fluid are measured, and
(C) in the correction of the parameter of the first driving pulse and the parameter of the second driving pulse,
such parameters of the first and second driving pulses that the densities of the first and second test patterns become a common target density for every color of the fluid are sought out,
the average of the sought-out parameters of the first driving pulses of the first nozzle row group is set as a common parameter of the first driving pulses in the first nozzle row group, and
the average of the sought-out parameters of the second driving pulses of the second nozzle row group is set as a common parameter of the second driving pulses in the second nozzle row group.

6. The manufacturing method of a fluid ejecting apparatus according to claim 1, wherein the correction of the parameters is further performed on the basis of a change in a density with the elapsed time from the formation of the first test pattern and the second test pattern.

7. The manufacturing method of a fluid ejecting apparatus according to claim 1, further comprising:
forming a pattern for correction for performing the density correction for every pixel row composed of pixels arranged in the relative movement direction, on the medium; and
calculating a density correction value for correcting the density for every pixel row on the basis of the pattern for correction.

8. The manufacturing method of a fluid ejecting apparatus according to claim 7, wherein a density of the formed pattern for correction is measured for every pixel row, and then the density correction value is calculated on the basis of the measured density for every pixel row.

9. A fluid ejecting apparatus comprising:
a first nozzle row which ejects fluid in accordance with a first driving pulse; and
a second nozzle row which ejects the fluid in accordance with a second driving pulse,
wherein the first nozzle row forms a first test pattern by ejecting the fluid,
the second nozzle row forms a second test pattern by ejecting the fluid,
the density of the first test pattern and the density of second test pattern are measured, and
a parameter of the first driving pulse and a parameter of the second driving pulse are corrected such that the density of the first test pattern and the density of the second test pattern become a common target density.
